(19) United States
(12) Patent Application Publication
(10) Pub. No.: US 2014/0090848 A1
(43) Pub. Date: Apr. 3, 2014

(54) COMPOSITIONS AND METHODS FOR TREATING A WELL PENETRATING A SUBTERRANEAN FORMATION

(71) Applicants: Leiming Li, Sugar Land, TX (US); Bruno Drochon, Houston, TX (US); Li Jiang, Katy, TX (US)

(72) Inventors: Leiming Li, Sugar Land, TX (US); Bruno Drochon, Houston, TX (US); Li Jiang, Katy, TX (US)

(21) Appl. No.: 13/630,332

(22) Filed: Sep. 28, 2012

(51) Int. Cl. C09K 8/08; C09K 8/68; C09K 8/575; E21B 37/00; C09K 8/00; E21B 43/16; E21B 43/26; E21B 43/25; C09K 8/12; C09K 8/52

(52) U.S. Cl. 166/308.1; 507/110; 507/120; 507/209; 507/225; 166/305.1; 166/312

(57) ABSTRACT

A method for treating a well penetrating subterranean formations comprising injecting into the well a composition comprising a high temperature stabilizer composition which comprises at least one mineral-reactive compound; wherein at least a part of the well is at a temperature of at least 120° C. is provided. Also provided is a composition for treating a well comprising a mineral-reactive compound.

### RELATED APPLICATION DATA

None.

### BACKGROUND

The statements in this section merely provide background information related to the present disclosure and may not constitute prior art.

Embodiments relate to compositions and methods for treating a well penetrating a subterranean formation. Water hardness can seriously affect the performance of well treatment fluids. Such impact generally arises from the presence of Mg²⁺ and/or Ca²⁺ ions in the well. Such ions may be present particularly where produced water, brackish and/or sea water is used in preparation of the well treatment fluid. For example, sea water has concentrations of Mg²⁺ of about 1 g/L. In oilfield produced water, Mg²⁺ concentrations vary from about 7 mg/L to several g/L.

At elevated temperatures such hard water ions can degrade well treatment fluid components resulting in degradation of such fluids. One result of such degradation may be lowering of viscosity, particularly in crosslinked well treatment fluids.

A method and composition for treating wells which would prevent such negative impact would be desirable. Such method and composition would be particularly useful in those situations in which fresh water is not readily available to well operations.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In a first embodiment, the process comprises injecting a composition comprising a high temperature stabilizer composition which comprises at least one mineral-reactive compound into the well; wherein at least a part of the well is at a temperature of at least 120° C.

In an alternative, the composition comprises at least one well treatment fluid and at least one mineral-reactive compound.

### BRIEF DESCRIPTION OF THE DRAWINGS

These and other features and advantages will be better understood by reference to the following detailed description when considered in conjunction with the accompanying drawings.

FIG. 1 is a graph illustrating the viscosity of a first well treatment fluid with and without a composition comprising a mineral reactive compound;

FIG. 2 is a graph illustrating the viscosity of a second well treatment fluid with and without a composition comprising a mineral reactive compound; and

FIG. 3 is a graph illustrating the viscosity of a third well treatment fluid with and without a composition comprising a mineral reactive compound.

### DETAILED DESCRIPTION OF SOME ILLUSTRATIVE EMBODIMENTS

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that the Applicant appreciates and understands that any and all data points within the range are to be considered to have been specified, and that the Applicant possessed knowledge of the entire range and all points within the range.

As used herein, “embodiments” refers to non-limiting examples of the application disclosed herein, whether claimed or not, which may be employed or present alone or in any combination or permutation with one or more other embodiments. Each embodiment disclosed herein should be regarded both as an added feature to be used with one or more other embodiments, as well as an alternative to be used separately or in lieu of one or more other embodiments. It should be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

A method and composition for treating a well penetrating a subterranean formation are provided.

In some embodiments, the method comprises injecting a composition comprising a high temperature stabilizer composition which comprises at least one mineral-reactive compound into the well; wherein at least a part of the well is at a temperature of at least 120° C.

In some embodiments, the composition for treating a well penetrating a subterranean formation comprises at least one well treatment fluid and at least one mineral-reactive compound.

In some embodiments, mineral-reactive compounds include any compound which is capable of reacting with, chelating, or otherwise removing Mg²⁺ and/or Ca²⁺ from fluids used in wells penetrating a subterranean formation. Exemplary mineral-reactive compounds include PO₄³⁻, HPO₄²⁻, H₃PO₄, H₂PO₄⁻, orthophosphate-based additives, polyphosphate-based additives, NaF, NH₄HF², NaOH, KOH, OH⁻, carbonate, Na₂CO₃, crystalline silicates, amorphous silicates, fatty acids, aspartic acid, aspartate, organosulfates with 1-18 carbons containing either linear, branched or aromatic moieties, alkylsulfonic acid with 1-18 carbons containing either linear, branched or aromatic moieties, sulfonic acid with 1-18 carbons containing either linear, branched or aromatic moieties, phosphonic acid with 1-18 carbons containing either linear, branched or aromatic moieties, alkylphosphonic acid with 1-18 carbons containing either linear, branched or aromatic moieties, polyamino carboxylic acid, ethylenediaminetetraacetic acid (EDTA), nitrilotriacetic acid, the related salts and esters, and combinations of any two or more thereof.

In some embodiments, mineral-reactive compounds useful in embodiments of the method and composition include saturated and unsaturated fatty acids having from 6 to 30 carbon atoms, containing either linear, branched, or aromatic moieties. In a particular embodiment, the fatty acid based mineral-reactive compound is one or more saturated fatty acids having from 12 to 18 carbon atoms. All individual ranges from 6 to 30 carbon atoms are included herein and disclosed herein; for example, fatty acids useful in the method and composition may have a number of carbon atoms from a lower limit of 6, 8, 10, 12, 14, 16, 18, 20, 22, 24, 26 or 28, and an upper limit of 7, 9, 11, 13, 15, 17, 19, 21, 23, 25, 27, 29 or 30. For example, the fatty acid may have from 6 to 30 carbon atoms, or in the alternative, from 6 to 18 carbon atoms, or in the alternative, from 10 to 18 carbon atoms, or in the alternative, from 15 to 30 carbon atoms, or in the alternative, from 18 to 25 carbon atoms.

The mineral-reactive compound may be present in the high temperature stabilizer in any amount from greater than 0 to about 5 percent by weight of the treatment fluid. The amount of mineral-reactive compound generally depends upon the known or expected level of Mg and/or Ca in the well. All individual values and sub-ranges from greater than 0 to 5 percent by weight are included herein and disclosed herein; for example, the amount of mineral-reactive compound in the treatment fluid can be from a lower limit of about 0 weight percent to an upper limit of about 5 weight percent. For example, the amount of mineral-reactive compound in the treatment fluid may be in the range of from greater than 0 to 1 percent by weight, or in the alternative, the amount of mineral-reactive compound in the treatment fluid may be in the range of from greater than 0 to 0.5 percent by weight.

In certain embodiments, the process results in a lower concentration of Mg in the well. Such post-treatment Mg concentrations may be less than 0.6 g/L. All individual values and sub-ranges from less than 0.6 g/L are included herein and disclosed herein; for example, the amount of Mg in the well following treatment with the treatment fluid may be less than 0.6 g/L; or in the alternative, less than 0.5 g/L; or in the alternative, less than 0.03 g/L; or in the alternative, less than 0.001 g/L.

In embodiments, the process further comprises injecting one or more well treatment fluids into the well. Exemplary well treatment fluids include fracturing fluids, sand control fluids, coiled tubing cleanout fluids, diverting fluids, drilling fluids, pills, and completion fluids.

In a particular embodiment, the process further comprises injecting one or more well treatment fluids selected from the group consisting of slickwater, linear polymer fluids, foamed fluids, energized fluids, viscoelastic surfactants and combinations of two or more thereof.

In a particular embodiment, a fracturing fluid is injected into the well. Any fracturing fluid may be used in embodiments of the process, including linear or non-crosslinked polymers and crosslinked polymers.

While linear or non-crosslinked polymer systems can be used in an embodiment, at higher temperatures they generally require higher polymer levels for the same rheological modification. In some embodiments, the fracturing fluids used may further include a crosslinker. Adding crosslinkers to the fluid may further augment the viscosity of the fluid. Suitable crosslinkers may comprise a chemical compound containing a polyvalent ion such as, but not necessarily limited to, boron or a metal such as chromium, iron, aluminum, titanium, antimony and zirconium, or mixtures of polyvalent ions. Suitable boron crosslinked polymers systems include by non-limiting example, guar and substituted guars crosslinked with boric acid, sodium tetraborate, and encapsulated borates; borate crosslinkers may be used with buffers and pH control agents such as sodium hydroxide, magnesium oxide, sodium sesquicarbonate, and sodium carbonate, amines (such as hydroxyalkyl amines, anilines, pyridines, pyrimidines, quinolines, and pyrrolidines), and carboxylates such as acetates and oxalates; and with crosslink delay agents such as sorbitol, aldehydes, and sodium gluconate. Borate crosslinked fracturing fluids useful in embodiments of the process and composition include those disclosed in U.S. Patent Application Publications 20050045335; 20030083205; and 20030022796, the disclosures of which are incorporated herein by reference.

Suitable zirconium crosslinked polymer systems include by non-limiting example, those crosslinked by zirconium complexes such as lactates (for example sodium zirconium lactate), triethanolamines, 2,2′-iminodiethanol, amino acids, and with mixtures of these ligands, including when adjusted, for example, with bicarbonate. Suitable titanates include by non-limiting example, lactates and triethanolamines, and mixtures, for example delayed with hydroxyacetic acid.

Guar-based fluids include, for example, guar gums and guar derivatives, such as hydroxypropyl guar (HPG), carboxymethyl guar (CMG), carboxymethylhydroxypropyl guar (CMHPG), and combinations thereof.

The fracturing fluids may alternatively comprise water-dispersible, linear, nonionic, hydroxyalkyl galactomannan polymer or a substituted hydroxyalkyl galactomannan polymer. Examples of useful hydroxyalkyl galactomannan polymers include, but are not limited to, hydroxy-C₁-C₄-alkyl galactomannans, such as hydroxy-C₁-C₄-alkyl guars. Preferred examples of such hydroxyalkyl guars include hydroxyethyl guar (HE guar), hydroxypropyl guar (HP guar), and hydroxybutyl guar (HB guar), and mixed C₂-C₄, C₂/C₃, C₃/C₄, or C₂/C₄ hydroxyalkyl guars. Hydroxymethyl groups can also be present in any of these.

As used herein, substituted hydroxyalkyl galactomannan polymers are obtainable as substituted derivatives of the hydroxy-C₁-C₄-alkyl galactomannans, which include: 1) hydrophobically-modified hydroxyalkyl galactomannans, e.g., C₁-C₂₄-alkyl-substituted hydroxyalkyl galactomannans, e.g., wherein the amount of alkyl substituent groups is preferably about 2% by weight or less of the hydroxyalkyl galactomannan; and 2) poly(oxyalkylene)-grafted galactomannans (see, e.g., A. Bahamdan & W. H. Daly, in Proc. 8th Polymers for Adv. Technol. Intl Symp. (Budapest, Hungary, September 2005) (PEG- and/or PPG-grafting is illustrated, although applied therein to carboxymethyl guar, rather than directly to a galactomannan)). Poly(oxyalkylene)-grafts thereof can comprise two or more than two oxyalkylene residues; and the oxyalkylene residues can be C₁-C₄ oxyalkylenes. Mixed-substitution polymers comprising alkyl substituent groups and poly(oxyalkylene) substituent groups on the hydroxyalkyl galactomannan are also useful herein. In various embodiments of substituted hydroxyalkyl galactomannans, the ratio of alkyl and/or poly(oxyalkylene) substituent groups to mannosyl backbone residues can be about 1:25 or less, i.e. with at least one substituent per hydroxyalkyl galactomannan molecule; the ratio can be: at least or about 1:2000, 1:500, 1:100, or 1:50; or up to or about 1:50, 1:40, 1:35, or 1:30. Combinations of galactomannan polymers can also be used.

As used herein, galactomannans comprise a polymannose backbone attached to galactose branches that are present at an average ratio of from 1:1 to 1:5 galactose branches:mannose residues. The galactomannan can be natural or synthetic. Natural galactomannans useful herein include plant and microbial (e.g., fungal) galactomannans. In various embodiments, legume seed galactomannans can be used, examples of which include, but are not limited to: tara gum (e.g., from Cesalpinia spinosa seeds) and guar gum (e.g., from Cyamopsis tetragonoloba seeds). In addition, although embodiments may be described or exemplified with reference to guar, such as by reference to hydroxy-C₁-C₄-alkyl guars, such descriptions apply equally to other galactomannans, such as fenugreek gum and locust bean gum as well, and such descriptions apply equally to other polysaccharides such as xanthan or diutan.

Polyacrylamide and polyacrylate polymers and copolymer based fracturing fluids are also used typically in wells experiencing temperatures above 120° C.

Fracturing fluids useful in embodiments may include those disclosed in U.S. Pat. Nos. 7,786,050, 7,678,745, 784544, 8191632, and U.S. Patent Application Publication Nos. 2010-0175877, 2011-0030962, and 2012/080978, the disclosures of which are incorporated herein by reference.

In particular embodiments, the process minimizes the degradation of the polymer, and therefore, viscosity of the well treatment fluid. For example, at an elevated temperature, the post-treatment viscosity of the well treatment fluid may show a decrease of less than about 50% in comparison to the well treatment fluid in the absence of the composition comprising a high temperature stabilizer. All individual values and subranges from less than 50% are included herein and disclosed herein; for example, the decrease in viscosity at an elevated temperature may be from an upper limit of 49, 40, 35, 30, 25, 20 or 15%.

As used herein, the term “elevated temperature” means temperatures greater than or equal to 120° C. In alternative embodiments, the elevated temperature means greater than or equal to 150, 180, 200, 230, 250 or 270° C. In some embodiments, the “elevated temperature” has an upper limit of 290° C.

In some embodiments of the method, the high temperature stabilizer is added to a well treatment fluid during a step of hydrating or solvating the well treatment fluid. In such steps, the precipitation or settling of a reaction product of the mineral-reactive compound with the Mg and/or Ca is avoided. In certain embodiments, such reaction product may form colloidal particles suspended stably in the well treatment fluid.

In embodiments, the well treatment may involve a stage or stages of well treatment fluids containing a high temperature stabilizer and a stage or stages of well treatment fluids not containing a high temperature stabilizer. In stages containing a high temperature stabilizer, the amount of high temperature stabilizer may vary from stage to stage. Typically, the well treatment fluids in the stages including a high temperature stabilizer differ in composition from the well treatment fluids in the stages not including a high temperature stabilizer.

The method and composition disclosed herein may be used in conjunction with improved hydraulic fracturing methods, such as the methods disclosed in U.S. Pat. Nos. 6,776,235; 7,581,590; and 8,061,424, the disclosures of which are incorporated herein by reference. In such methods, proppant clusters, as opposed to a continuous proppant pack, are placed in a fractured subterranean formation so as to produce flow channels through which formation fluids may flow. Such proppant placement may be referred to heterogeneous proppant placement.

One embodiment provides a method further comprising sequentially injecting into the well, alternate stages of proppant-containing fracturing fluids having a contrast in their ability to transport propping agents to improve proppant placement.

Another embodiment provides a method further comprising: injecting into the well a fracturing fluid containing thickeners to create a fracture in the formation; and periodic introduction of proppant into the fracturing fluid to supply the proppant into the created fracture thereby forming proppant clusters within the fracture that prevent fracture closure and providing channels for flowing formation fluids between the clusters, wherein the periodic introduction of proppant comprises introducing either a reinforcing or consolidation material or both, thus increasing the strength of the proppant clusters formed into the fracture fluid, whereby volume of injection of proppant-containing fracturing fluid is less than the volume of injection of fluid containing no proppant to create smaller proppant clusters and larger channels between them for formation fluids to pass.

Yet another embodiment further comprising: injecting well treatment fluid comprising proppant and channelant through a wellbore into a fracture in a subterranean formation, wherein the channelant comprises a solid acid-precursor to generate acid in the fracture; placing the proppant in the fracture in a plurality of proppant clusters forming pillars spaced apart by the channelant; and, removing the channelant to form open channels around the pillars for fluid flow from the formation through the fracture toward the wellbore; wherein the treatment fluid comprises alternating volumes of proppant-rich fluid separated by volumes containing the channelant.

Accordingly, the current application discloses the following embodiments:

### Embodiment 1

A method for treating a well penetrating subterranean formations comprising:
injecting into the well a composition comprising a high temperature stabilizer composition which comprises at least one mineral-reactive compound;
wherein at least a part of the well is at a temperature of at least 120° C.

### Embodiment 2

The method according to embodiment 1, wherein the at least one mineral-reactive compound is selected from the group consisting of PO₄³⁻, HPO₄²⁻, H₃PO₄, H₂PO₄⁻, orthophosphate-based additives, polyphosphate-based additives, NaF, NH₄HF₂, NaOH, KOH, OH⁻, carbonate, Na₂CO₃, crystalline silicates, amorphous silicates, fatty acids, organosulfates with 1-18 carbons containing either linear, branched or aromatic moieties, alkylsulfonic acid with 1-18 carbons containing either linear, branched or aromatic moieties, sulfonic acid with 1-18 carbons containing either linear, branched or aromatic moieties, phosphonic acid with 1-18 carbons containing either linear, branched or aromatic moieties, alkylphosphonic acid with 1-18 carbons containing either linear, branched or aromatic moieties, polyamino carboxylic acid, ethylenediaminetetraacetic acid (EDTA), nitrilotriacetic acid, the related salts and esters, and combinations of any two or more thereof.

### Embodiment 3

The method according to any of embodiment 1 or 2, further comprising injecting into the well at least one well treatment fluid selected from the group consisting of fracturing fluids, sand control fluids, coiled tubing cleanout fluids, diverting fluids, drilling fluids, pills, and completion fluids.

### Embodiment 4

The method according to any of embodiments 1-3, further comprising injecting into the well a fracturing fluid comprising a guar-based compound, a polyacrylamide-based compound, or combination thereof.

### Embodiment 5

The method according to any of embodiments 1-4, wherein the fracturing fluid further comprises a crosslinker comprising a borate-based compound, Ti-based compound, Zr-based compound, or combinations of two or more thereof.

### Embodiment 6

The method according to any of embodiments 1-5, wherein the at least one mineral-reactive compound is selected from the group consisting of H₃PO₄, NaF, d-Na₂Si₂O₅, C₁₂-C₁₈ unsaturated fatty acids, and combinations of two or more thereof.

### Embodiment 7

The method according to any of embodiments 1-6, wherein the mineral reactive compound is a fatty acid selected from the group consisting of lauric acid, myristic acid, palmitic acid, and stearic acid.

### Embodiment 8

The method according to any of embodiments 1-7, wherein the well treatment fluid comprises produced water, brackish water or sea water.

### Embodiment 9

The method according to any of embodiments 1-8, wherein the well does not experience temperatures greater than 260° C.

### Embodiment 10

The method according to any of embodiments 1-9, wherein the injecting a fracturing fluid comprises hydrating a guar-based compound; and wherein the steps of injecting a high temperature stabilizer composition and injecting a fracturing fluid occur simultaneously.

### Embodiment 11

A composition for treating a well penetrating subterranean formations comprising:
at least one well treatment fluid; and
at least one mineral-reactive compound.

### Embodiment 12

The composition according to embodiment 11, wherein the at least one mineral-reactive compound is selected from the group consisting of PO₄³⁻, HPO₄²⁻, H₃PO₄, H₂PO₄⁻, orthophosphate-based additives, polyphosphate-based additives, NaF, NH₄HF₂, crystalline silicates, amorphous silicates, fatty acids, alkylsulfonic acid with 1-18 carbons containing either linear, branched or aromatic moieties, sulfonic acid with 1-18 carbons containing either linear, branched or aromatic moieties, phosphonic acid with 1-18 carbons containing either linear, branched or aromatic moieties, alkylphosphonic acid with 1-18 carbons containing either linear, branched or aromatic moieties, polyamino carboxylic acid, ethylenediaminetetraacetic acid (EDTA), nitrilotriacetic acid, the related salts and esters, and combinations of any two or more thereof.

### Embodiment 13

The composition according to embodiment 11 or 12, wherein the at least one well treatment fluid is selected from the group consisting of fracturing fluids, sand control fluids, coiled tubing cleanout fluids, diverting fluids, drilling fluids, pills, and completion fluids.

### Embodiment 14

The composition according to any of embodiments 11-13, wherein the at least one well treatment fluid is a fracturing fluid comprising a guar-based compound, a polyacrylamide-based compound, or combination thereof.

### Embodiment 15

The composition according to any of embodiments 11-14, further comprising a crosslinker selected from the group consisting of borate-based crosslinkers, Ti-based crosslinkers, Zr-based crosslinkers, and combinations of two or more thereof.

### Embodiment 16

The composition according to any of embodiments 11-15, wherein the mineral-reactive compound is selected from the group consisting of H₃PO₄, NaF, d-Na₂Si₂O₅, C₁₂-C₁₈ unsaturated fatty acids, and combinations of two or more thereof.

### Embodiment 17

The composition according to any of embodiments 11-16, wherein the mineral reactive compound is a fatty acid selected from the group consisting of lauric acid, myristic acid, palmitic acid, and stearic acid.

### Embodiment 18

The composition according to any of embodiments 11-17, wherein the well treatment fluid comprises produced water, brackish water or sea water.

### EXAMPLES

The following examples are illustrative but are not intended to limit the scope of the claims herein. In the following examples, 1 ppt is equal to about 0.12 g/L, and 1 gpt is equal to 0.1% by volume.

### Comparative Example 1

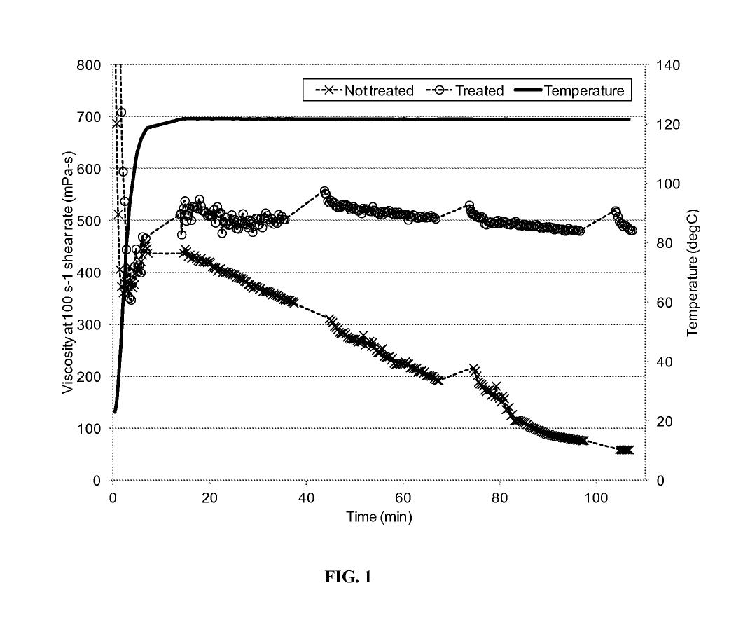

Comparative Example 1 was prepared with tap water, 2% KCl, 200 ppm Mg (by adding an appropriate amount of MgCl₂), 30 ppt guar, 1 gpt 85% triethanolamine solution, 10 ppt sodium thiosulfate pentahydrate, 2 gpt 30% NaOH solution, and 1.75 gpt proprietary borate crosslinker. Near the end of the guar hydration, 10% NaOH solution was added drop by drop to raise the fluid pH to about 8.6 while blending. The final gel pH at room temperature was about 11.5. The viscosity at 250° F. (121° C.) was measured with a Fann50-type viscometer, following the API RP 39 schedule. The result is shown in FIG. 1, with a dashed line and “X” marks. The fluid viscosity gradually decreased. The fluid viscosity dropped below 100 cP (at 100/s shear rate) at about 87 minutes. The baseline fluid which contained no Mg and no high temperature stabilizer (not shown in FIG. 1) with the same gel pH at room temperature (about 11.5) exhibited viscosity of about 500 cP (at 100/s shear rate) at 250° F. (121° C.) and 87 minutes.

### Example 1

### Phosphate-Based High Temperature Stabilizer

Example 1 was prepared with tap water, 2% KCl, 200 ppm Mg (by adding an appropriate amount of MgCl₂), 0.56 gpt 85% H₃PO₄ acid, as high temperature stabilizer, 30 ppt guar, 1 gpt 85% triethanolamine solution, 10 ppt sodium thiosulfate pentahydrate, 2 gpt 30% NaOH solution, and 1.75 gpt proprietary borate crosslinker. Near the end of the guar hydration, the 10% NaOH solution was added drop by drop to raise the linear fluid pH to about 8.4 while blending. More of the 30% NaOH solution (in addition to the 2 gpt of the 30% NaOH solution in the formula) was added later to adjust the gel pH to about 11.5 at RT, matching the pH of the baseline fluid. The viscosity at 250° F. (121° C.) was measured with a Fann50-type viscometer, following the API RP 39 schedule. The viscosity of Example is shown in FIG. 1, as a dashed line with open circles. The fluid viscosity of Example 1 (at 100/s shear rate) remained at about 500 cP for about 2 hours, similar to the viscosity of the baseline fluid.

### Comparative Example 2

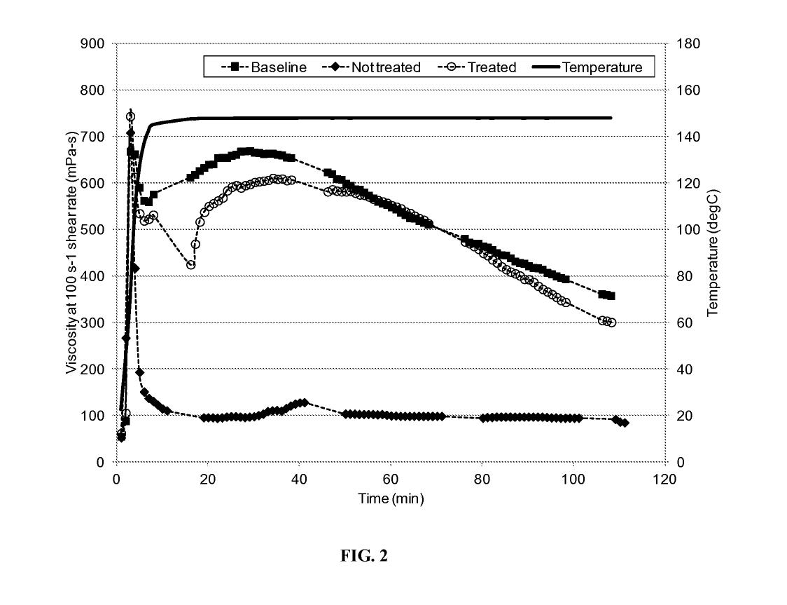

A baseline fracturing fluid without added Mg ions and without a high temperature stabilizer was prepared with deionized water, 0.5 g/L NaHCO₃, 30 ppt self-hydrating CMHPG, 0.5 gpt 25% glutaraldehyde, 1 gpt proprietary surfactant solution, 2 gpt 50% tetramethyl ammonium chloride solution, 20 ppt sodium thiosulfate pentahydrate, 1 gpt proprietary high temperature stabilizer and buffer), and 2.2 gpt proprietary high temperature crosslinker. The fluid pH was about 9.3 at room temperature (about 25° C.). The viscosity at 300° F. (148.9° C.) was measured with a Fann50-type viscometer, following the API RP 39 schedule. The viscosity as a function of time is shown in FIG. 2 (with a dashed line and solid squares).

### Comparative Example 3

Comparative example 3, which contained Mg²⁺, but without the high temperature stabilizer of the present application, was prepared with deionized water, 0.5 g/L NaHCO₃, 200 ppm Mg²⁺ (by adding an appropriate amount of MgCl₂), 30 ppt self-hydrating CMHPG, 0.5 gpt 25% glutaraldehyde, 1 gpt proprietary surfactant solution, 2 gpt 50% tetramethyl ammonium chloride solution, 20 ppt sodium thiosulfate pentahydrate, 1 gpt proprietary high temperature stabilizer and buffer, and 2.2 gpt proprietary high temperature crosslinker. The fluid pH was about 9.3 at room temperature. The viscosity at 300° F. (148.9° C.) was measured and shown in FIG. 2 (with a dashed line and solid diamonds).

### Example 2

### Fluoride-Based High Temperature Stabilizer

Example 2 was prepared with deionized water, 0.5 g/L NaHCO₃, 200 ppm Mg²⁺ (by adding an appropriate amount of MgCl₂), 691 mg/L NaF, as a high temperature stabilizer of the present application, 30 ppt self-hydrating CMHPG, 0.5 gpt 25% glutaraldehyde, 1 gpt proprietary surfactant solution, 2 gpt 50% tetramethyl ammonium chloride solution, 20 ppt sodium thiosulfate pentahydrate, 1 gpt proprietary high temperature stabilizer and buffer, and 2.2 gpt proprietary high temperature crosslinker. The fluid pH was about 9.3 at room temperature. The viscosity at 300° F. (148.9° C.) was measured and is shown in FIG. 2 (with a dashed line and open circles).

FIG. 2 illustrates that the addition of 200 ppm Mg²⁺ without the high temperature stabilizer treatment of the present application (Comparative Example 3) damaged the fracturing fluid significantly at 300° F. (148.9° C.). In contrast, with the fluoride high temperature stabilizer treatment, the fracturing fluid viscosity remained very close to that of the baseline fluid (Comparative Example 2), which contained no Mg ions.

### Comparative Example 4

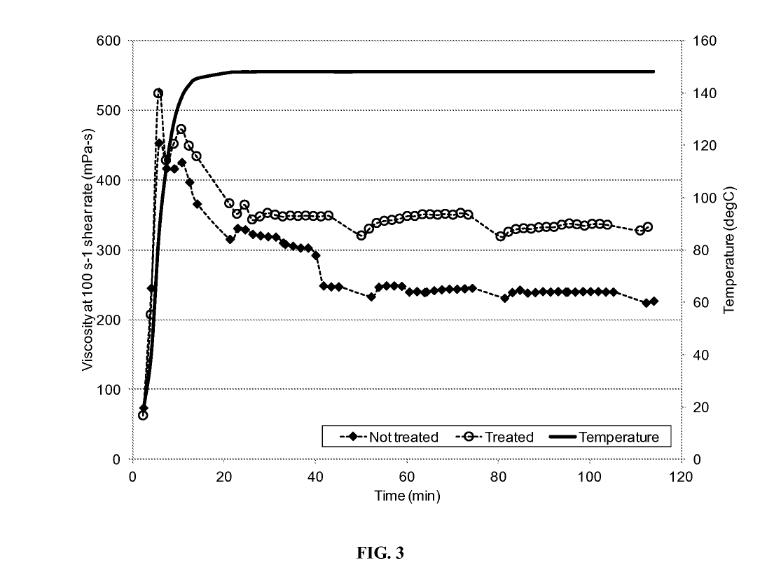

Comparative Example 4, which contained Mg²⁺, but without the high temperature stabilizer of the present application, was prepared with Sugar Land, Tex., tap water, 100 ppm Mg²⁺ (by adding an appropriate amount of MgCl₂), 30 ppt proprietary poly (acrylamide-acrylate), 2 gpt proprietary surfactant solution, 5 ppt sodium thiosulfate pentahydrate, and 4 gpt proprietary zirconate crosslinker. The fluid pH was adjusted to about 8 at room temperature. The viscosity at 300° F. (148.9° C.) was measured and shown in FIG. 3 (with a dashed line and solid diamonds).

### Example 3

### Fluoride-Based High Temperature Stabilizer

Example 3 was prepared with Sugar Land, Tex., tap water, 100 ppm Mg²⁺ (by adding an appropriate amount of MgCl₂), 345 mg/L NaF, as high temperature stabilizer of the present application, 30 ppt proprietary poly (acrylamide-acrylate), 2 gpt proprietary surfactant solution, 5 ppt sodium thiosulfate pentahydrate, and 4 gpt proprietary zirconate crosslinker. The fluid pH was adjusted to about 8 at room temperature. The viscosity at 300° F. (148.9° C.) was measured and is shown in FIG. 3 (with a dashed line and open circles).

FIG. 3 illustrates that in the presence of 100 ppm Mg²⁺, the fracturing fluid with the fluoride high temperature stabilizer treatment showed significantly better viscosity than the fluid without the high temperature stabilizer treatment of the present application (Comparative Example 4).

Any element in the examples may be replaced by any one of numerous equivalent alternatives, only some of which are disclosed in the specification. Although only a few example embodiments have been described in detail above, those skilled in the art will readily appreciate that many modifications are possible in the example embodiments without materially departing from the concepts described herein. The present invention may be embodied in other forms without departing from the spirit and the essential attributes thereof, and, accordingly, reference should be made to the appended claims, rather than to the foregoing specification, as indicating the scope of the invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

We claim:

1. A method for treating a well penetrating subterranean formations comprising:
injecting into the well a composition comprising a high temperature stabilizer composition which comprises at least one mineral-reactive compound;
wherein at least a part of the well is at a temperature of at least 120° C.

2. The method according to claim 1, wherein the at least one mineral-reactive compound is selected from the group consisting of PO₄³⁻, HPO₄²⁻, H₃PO₄, H₂PO₄⁻, orthophosphate-based additives, polyphosphate-based additives, NaF, NH₄HF₂, NaOH, KOH, OH⁻, carbonate, Na₂CO₃, crystalline silicates, amorphous silicates, fatty acids, organosulfates with 1-18 carbons containing either linear, branched or aromatic moieties, alkylsulfonic acid with 1-18 carbons containing either linear, branched or aromatic moieties, sulfonic acid with 1-18 carbons containing either linear, branched or aromatic moieties, phosphonic acid with 1-18 carbons containing either linear, branched or aromatic moieties, alkylphosphonic acid with 1-18 carbons containing either linear, branched or aromatic moieties, polyamino carboxylic acid, ethylenediaminetetraacetic acid (EDTA), nitrilotriacetic acid, the related salts and esters, and combinations of any two or more thereof.

3. The method according to claim 1, further comprising injecting into the well at least one well treatment fluid selected from the group consisting of fracturing fluids, sand control fluids, coiled tubing cleanout fluids, diverting fluids, drilling fluids, pills, and completion fluids.

4. The method according to claim 1, further comprising injecting into the well a fracturing fluid comprising a guar-based compound, a polyacrylamide-based compound, or combination thereof.

5. The method according to claim 4, wherein the fracturing fluid further comprises a crosslinker comprising a borate-based compound, Ti-based compound, Zr-based compound, or combinations of two or more thereof.

6. The method according to claim 1, wherein the at least one mineral-reactive compound is selected from the group consisting of H₃PO₄, NaF, d-Na₂Si₂O₅, C₁₂-C₁₈ unsaturated fatty acids, and combinations of two or more thereof.

7. The method according to claim 1, wherein the mineral reactive compound is a fatty acid selected from the group consisting of lauric acid, myristic acid, palmitic acid, and stearic acid.

8. The method according to claim 3, wherein the well treatment fluid comprises produced water, brackish water or sea water.

9. The method according to claim 1, wherein the well does not experience temperatures greater than 260° C.

10. The method according to claim 4, wherein the injecting a fracturing fluid comprises hydrating a guar-based compound; and wherein the steps of injecting a high temperature stabilizer composition and injecting a fracturing fluid occur simultaneously.

11. A composition for treating a well penetrating subterranean formations comprising:
at least one well treatment fluid; and
at least one mineral-reactive compound.

12. The composition according to claim 11, wherein the at least one mineral-reactive compound is selected from the group consisting of PO₄³⁻, HPO₄²⁻, H₃PO₄, H₂PO₄⁻, orthophosphate-based additives, polyphosphate-based additives, NaF, NH₄HF₂, crystalline silicates, amorphous silicates, fatty acids, alkylsulfonic acid with 1-18 carbons containing either linear, branched or aromatic moieties, sulfonic acid with 1-18 carbons containing either linear, branched or aromatic moieties, phosphonic acid with 1-18 carbons containing either linear, branched or aromatic moieties, alkylphosphonic acid with 1-18 carbons containing either linear, branched or aromatic moieties, polyamino carboxylic acid, ethylenediaminetetraacetic acid (EDTA), nitrilotriacetic acid, the related salts and esters, and combinations of any two or more thereof.

13. The composition according to claim 11, wherein the at least one well treatment fluid is selected from the group consisting of fracturing fluids, sand control fluids, coiled tubing cleanout fluids, diverting fluids, drilling fluids, pills, and completion fluids.

14. The composition according to claim 11, wherein the at least one well treatment fluid is a fracturing fluid comprising a guar-based compound, a polyacrylamide-based compound, or combination thereof.

15. The composition according to claim 14, further comprising a crosslinker selected from the group consisting of borate-based crosslinkers, Ti-based crosslinkers, Zr-based crosslinkers, and combinations of two or more thereof.

16. The composition according to claim 11, wherein the mineral-reactive compound is selected from the group consisting of H₃PO₄, NaF, d-Na₂Si₂O₅, C₁₂-C₁₈ unsaturated fatty acids, and combinations of two or more thereof.

17. The composition according to claim 11, wherein the mineral reactive compound is a fatty acid selected from the group consisting of lauric acid, myristic acid, palmitic acid, and stearic acid.

18. The composition according to claim 11, wherein the well treatment fluid comprises produced water, brackish water or sea water.
